(19) United States
(12) Patent Application Publication
(10) Pub. No.: US 2008/0167928 A1
(43) Pub. Date: Jul. 10, 2008

(54) Method and System for Using a Component Business Model to Support Value Based Pricing of Business Solutions

(76) Inventors: Rong Zeng Cao, Beijing (CN); Wei Ding, Beijing (CN); David Bernard Flaxer, Port Hadlock, WA (US); Robert H. Guttman, Stamford, CT (US); Juhnyoung Lee, Yorktown Heights, NY (US); Chunhua Tian, Beijing (CN)

Correspondence Address: Whitham, Curtis, Christofferson & Cook, P.C., Suite 340, 11491 Sunset Hills Road, Reston, VA, 20190, US

(21) Appl. No.: 11/620,155

(22) Filed: Jan. 5, 2007

(51) Int. Cl. G06Q 10/00

(52) U.S. Cl. 705/8

(57) ABSTRACT

A method, system and service for using a Component Business Model (CBM) of an enterprise to support value based pricing of business solutions. Business solutions are composed from, and are described in terms of, services exposed by business components. Pricing is represented as the product of iterative negotiations between a solution provider and a solution consumer. Both the provider and the consumer are analyzed in terms of constituent services. Value based pricing is applied to the constituent services, and a value based pricing schedule for the provider or the consumer is constructed from an evaluation of pricing schedules for the respective constituent services. The value based pricing schedules are themselves configured from a plurality of pricing strategies, the configuration being designed to optimize a pricing schedule for the mutual benefit of the provider and consumer.

This invention is related to commonly owned patent application Ser. No. 11/176,371 for “SYSTEM AND METHOD FOR ALIGNMENT OF AN ENTERPRISE TO A COMPONENT BUSINESS MODEL” which is incorporated by reference herein.

### BACKGROUND OF THE INVENTION

1. Field of the Invention

The present invention generally relates to component based business models and, more particularly, to using a component business model to support value based pricing of business solutions.

2. Background Description

Business solutions need flexibility in design and configuration, therefore pricing models needs to be flexible. It is generally difficult to accurately price business solutions. Not all business solutions have established pricing benchmarks and metrics. Therefore it is very hard to evaluate price. A “one price fits all” approach does not work in today's marketplace. Business opportunities may be lost with single price strategies. Therefore multiple pricing strategies need to be supported by the business. This results in added complexity and difficulty in arriving at good pricing decisions.

Business solutions need to fit within the organizing concept of the business and need to be aligned with strategic business objectives. It is difficult to keep business solutions in harmony with the business purpose, strategy and organization. Pricing of business solutions needs to be kept aligned with other aspects of the enterprise, such as resources, processes, people and technology. Further, business solutions need to reflect business transformation goals of the enterprise.

Service oriented architectures introduce the concept of developing business solutions from compositions of business services. Pricing these types of composed solutions is challenging. Business services, which make up business solutions, are not disconnected elements of the enterprise; they need to be integrated within the organizing framework of the business.

Negotiation between a solution provider and a solution consumer is a complex and iterative process. Both the provider and consumer support “networks” of service providers and service consumers, respectively. It is difficult to understand and evaluate these dependencies.

Pricing a solution is part of a larger value chain ecosystem. Consequences of changes to price may ripple through the enterprise, and unless the larger ecosystem is included in the pricing strategy these consequences may be unintended.

Selecting an effective price strategy is a key factor in driving the success of a business. This applies to both the provider who is determining a cost for their business solution and the consumer who is calculating their available budget to purchase a business solution. Value based pricing enhances flexibility in the negotiation process by introducing the concept of configurations of pricing strategies packaged into a single pricing schedule. The idea of a “one price” policy has little merit in today's commerce, and the business requirement for innovative pricing strategies and price dispersion has long been recognized. Technology advances have enabled more sophisticated pricing models, especially in electronic marketplaces and other forums that are supported by digital transactions and machine computation. For example, electronic commerce has enabled new pricing strategies such as bundling, differential pricing and per-use-fees. Technology is also enabling composition of business solutions from a palette of business services such as those realized by Web Services and other service oriented architectures. Much progress has been made to support service composition, from the formalization of languages, such as Web Services Development Language (WSDL), through the development of composition logic. Business solutions exist within a larger context, in which multiple businesses cooperate to achieve success. In this model, a value chain of producers and consumers exists, forming interdependences such that what affects one business in the chain can dramatically affect another up or down stream. Pricing issues play a key role in value chains and here again value based pricing can play a role in facilitating cooperation. Various business models have been examined to attempt to support value chains in an electronic commerce environment.

It is incumbent upon businesses to transform their models in order to better plan and execute business objectives in this dynamic and service oriented environment. Business decomposition is an effective paradigm, in which the business is logically seen as a set of independent components that collaborate to achieve business goals. Conveniently, a decomposed model of the business can be extended and enhanced to include a recognition and specification of business services.

Service composition and value chains, coupled with a decomposition model of the business, introduce hard challenges enabling mutually beneficial business collaboration, particularly in the area of pricing of business solutions. Business collaboration, which is generally based on mutual self-interest, has a dependency on the accurate and effective determination of producer cost and consumer budget, which is made even more complex with the introduction of a flexible multi-strategic value based price mechanism. There is a need to provide solutions to these challenges.

### SUMMARY OF THE INVENTION

It is therefore an object of the present invention to provide a view of the enterprise that places pricing strategy and methods within the larger value chain ecosystem.

A further object of the invention is to leverage a services oriented view of the enterprise to understand and evaluate the effect of dependencies between provider and consumer support networks upon price negotiation.

It is also an object of the invention to use an organizing framework for the business to facilitate pricing of business solutions composed of services.

Yet another object of the invention is to provide a pricing methodology that maintains alignment of a business solution and its pricing with other aspects of the enterprise, including transformation goals.

Another object of the invention is to provide a pricing methodology that facilitates benchmarks and metrics.

It is a further object of the invention to provide a pricing methodology that can be flexibly adapted to different business opportunities.

The present invention provides solutions to some of these problems by first establishing a basic framework and organizing concept and then presenting several mathematical techniques for value based pricing in this environment.

The invention is designed to operate within a value pricing paradigm having several attributes. First, the notion of value is an abstraction that is defined by the observer. There are infinite criteria for establishing what value means, and what is of benefit to one entity may not have the same worth to another. So, for this discussion, value is a concept that specifies what is being examined, and provides a unit of measure and method for its calculation. Value pricing is the set of criteria that is focused on optimizing, for the mutual benefit of consumer and provider, allocation of the difference between value to the consumer and cost to the provider of the specified services.

One needs to decide on what is of value that is being priced and put forward as a business solution. A business solution delivers some specified set of capabilities that supports a business objective. It includes the people, technology, process, resource, etc. that enable the business to achieve its purpose. A business solution can provide wide ranging capabilities. The perceived complexity that enables a capability is based on the point of view of the observer, thus establishing the notion of relative granularity. For example, a solution may appear from the consumer's point of view as a simple transaction, but from the provider's viewpoint may be an intricate and lengthy interaction between many business services. So, a business solution may in fact be a single business service or an aggregation of services. On the other hand, the consumer may also view a solution as a complex interaction among many business services that are consumers of the solution.

The idea of relative granularity is based on the level of decomposition of business capabilities that is suitable for management of the business. A business value can be applied to every business solution. And since a business solution is a composition of one or more business services the value of the business solution can be viewed as the composition of values of the business services that support it. The invention provides a method for calculating the value of a business solution as a composition of the values of component services.

The objective of value based pricing is to optimize a pricing schedule for the mutual benefit of the provider and consumer, based on an evaluation of criteria that results in setting of a price as a function of the expected value to be derived. The invention uses CBM analysis techniques to directly relate pricing criteria to the business solution. The CBM organizing framework and world view effectively represents business solutions as an interaction of business components. Value pricing can be introduced as yet another evaluation technique applied to business solutions represented via the CBM framework.

Value pricing is a business concept that can be closely coupled to the business strategy and evaluation capabilities offered by CBM. In both CBM and value pricing the business solution is viewed as a composition of business services, so a mapping between the two is direct and to the point. CBM defines key concepts (business solution, business components, business services and business activities, business criteria, and business decomposition) that are all perceived as central to the notion of value pricing.

A CBM business service provides a capability that is enabled through an identified composition of people, process, technology, and other factors. By applying value pricing criteria and methods to a CBM service, a value price for the service can be determined that considers all these factors. A CBM business solution is seen as a composition of CBM business services. Therefore, the value pricing of a CBM solution is determined by evaluation of the composition of the value pricing associated with each business service composing the solution. Implicit in CBM is the support of business decomposition and service outsourcing. Value pricing is intricately woven with the outsourcing option. CBM establishes reusable industry maps and standards. By incorporating value pricing into CBM, this information can be reused, thus establishing a benchmark for pricing structures.

The invention discloses the following unique and novel aspects of integrating CBM and Value Pricing. The invention introduces pricing attributes for CBM components and services, and enables analysis of pricing for business solutions as a new evaluation technique within the CBM framework. This methodology enables CBM to support pricing decisions, analysis, plans, collaboration and management based on one or more “pricing strategies” (e.g. fixed cost, price by value, price by use). CBM's capability to evaluate and define business solutions as a collaboration of business components, interacting through the business services they expose and introduces pricing strategies as an attribute of business services, is extended. A metamodel extension of CBM that aggregates metrics, benchmarks and other pricing information mapped to CBM components, business services and other CBM elements is established through the methodology of the invention. The invention also discloses a method extending CBM that enables pricing attribution of CBM components and business services, so as to evaluate and generate pricing of business solutions.

Further, the invention describes a new middleware service responsible for capturing business pricing metrics from a plurality of sources and maps them into CBM components and elements. This middleware “brokering” service obviates the need for existing pricing sources to change their procedures or data in order to interoperate with the CBM model. The invention also establishes a CBM based tool interface to support: (1) the specification of pricing strategies for CBM components, and the business services exposed by these components; and (2) the evaluation and recommendation of pricing for business solutions based on a plurality of pricing strategies. A “pricing composition” technique is disclosed, based on the evaluation of pricing strategies for all the business services that participate in a business solution. Pricing composition is directly enabled by the CBM model, methods and tool, as described herein.

The invention also introduces the concept of a “value pricing schedule”, which is defined as a configuration of one or more pricing strategies, which when taken as a whole, represents a satisfactory cost or payment for a business solution. The invention supports a method for negotiating a pricing schedule of a business solution for the mutual benefit of the provider and consumer, based on an evaluation of criteria that results in setting of a price as a function of the expected value to be derived. It is then possible to extend CBM business templates, by industry, based on best practices, to establish pricing strategies, recommendations, benchmarks and standards.

The invention uses the Component Business Model (CBM) described in related patent application Ser. No. 11/176,371 for “SYSTEM AND METHOD FOR ALIGNMENT OF AN ENTERPRISE TO A COMPONENT BUSINESS MODEL” (hereafter termed “the above referenced foundation patent application”). CBM provides a logical and comprehensive view of the enterprise, in terms that cut across commercial enterprises in general and industries in particular. The component business model as described in the above referenced foundation patent application is based upon a logical partitioning of business activities into non-overlapping managing concepts, each managing concept being active at the three levels of management accountability: providing direction to the business, controlling how the business operates, and executing the operations of the business. The term “managing concept” is specially defined as described in the above referenced foundation patent application, and is not literally a “managing concept” as that phrase would be understood in the art. For the purpose of the present invention, as for the related invention, “managing concept” is the term associated with the following aspects of the partitioning methodology. First, the methodology is a partitioning methodology. The idea is to begin with a whole and partition the whole into necessarily non-overlapping parts. Second, experience has shown that the partitioning process works best when addressed to an asset of the business. The asset can be further described by attributes. Third, the managing concept must include mechanisms for doing something commercially useful with the asset. For a sensibly defined managing concept these mechanisms must cover the full range of management accountability levels (i.e. direct, control and execute). Managing concepts are further partitioned into components, which are cohesive groups of activities. The boundaries of a component usually fall within a single management accountability level. It is important to emphasize that the boundaries between managing concepts (and between components within managing concepts) are logical rather than physical.

The invention focuses on the value based pricing of “business solutions”, which is abstractly defined as the set of capabilities that enable or add value to the enterprise. In a Component Business Model, the structure of a business is partitioned into discrete business components that are assigned specific purposes and are endowed with resources to achieve those purposes. Business components interact to achieve business goals, and do so by exposing their capabilities through business services they offer. Business services have suitable levels of granularity offering constituent units of function, which when selectively chosen and composed, form business solutions. We claim they are also suitable units for value based pricing, the implication being that pricing for a given business solution is an evaluation of the value based pricing of its assemblage of constituent business services. The benefits of this “value based price composition” approach offers closer alignment of pricing evaluation to the business plan, and greater accuracy for the pricing plan, coupled with increased flexibility to compose, modify, calculate and articulate pricing for business solutions.

An aspect of the invention is a method for pricing a business solution. The method describes the business solution as a composition of services, where each service exposed by a corresponding business component in a component business model (CBM) of an enterprise. The method develops a value based pricing schedule for the business solution, where the pricing schedule is configured from a plurality of pricing strategies in order to optimize a mutual benefit to a solution provider and a solution consumer. The method then applies the value based pricing schedule to each of the services constituting said composition, and composes a value based pricing schedule for the business solution from the constituent pricing schedules.

Another aspect of the method is the mapping of pricing information to the component business model, and displaying the mapped pricing information on a map of the component business model. The method can be applied by the solution provider to the constituent services contributing to the business solution, and can also be applied by the solution consumer to the constituent services consuming the business solution.

In another aspect of the invention, the value based pricing schedule may be iteratively negotiated between the solution provider and the solution consumer. And the negotiating process is further comprised of one or more of: setting of a budget by the solution consumer, and accommodating by the solution provider to the set budget by allocating value pricing across the constituent services contributing to the business solution; setting of a value based pricing schedule by the solution provider by aggregating value based pricing schedules from the constituent services contributing to the business solution, and accommodating by the solution consumer to the value based pricing schedule set by the solution provider; setting of a cost by the solution provider, and accommodating by the solution consumer to the set cost by allocating value pricing across the constituent services consuming the business solution; and setting of a value based pricing schedule by the solution consumer by aggregating value based pricing schedules from the constituent services consuming the business solution, and accommodating by the solution provider to the value based pricing schedule set by the solution consumer.

In yet another aspect of the invention, the mapping is performed by a value pricing analytic service, which can also develop a value based pricing schedule. A further aspect of the invention is a system comprising means for implementing the foregoing method. It is also an aspect of the invention to use the foregoing method to implement a service for pricing a business solution.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a simplified representation of a Component Business Model metamodel.

FIG. 2 is a schematic diagram showing a business solution choreographed as a linear composition of services of CBM components.

FIG. 3 is a schematic diagram showing an exemplar service composition from components displayed on a CBM map.

FIG. 4 is an extension of the metamodel shown in FIG. 1, showing value based price composition from component services.

FIG. 5 is a schematic diagram showing a model of value based price negotiation.

FIG. 6 is a schematic diagram of a simple supply chain.

FIGS. 7-10 are schematic diagrams showing value based pricing in each of four basic variations: consumer sets a budget and provider accommodates by allocating value pricing across services (FIG. 7); provider sets value price composed from services and consumer accommodates by adjusting its budget (FIG. 8); provider sets cost and consumer accommodates by allocating value pricing across services (FIG. 9); and consumer sets value price composed from services and provider accommodates by setting cost (FIG. 10).

FIG. 11 is a flow diagram of the price negotiation process, including all of the variations described in FIGS. 7-10.

FIG. 12 is diagram showing a variable value based price schedule composed of different business pricing strategies.

FIG. 13 is a schematic diagram showing application of CBM analysis to the calculation of value pricing.

FIG. 14 is a schematic diagram showing composition of a value price schedule for a business solution from value price schedules of component services.

FIG. 15 is a schematic diagram showing CBM as a lens into value based pricing.

FIG. 16 is a further extension of a CBM metamodel shown in FIGS. 1 and 4 to support value based pricing negotiations between consumer and provider.

FIG. 17 is a flow chart of a CBM based method for supporting value based pricing.

FIG. 18 is a schematic diagram of the CBM value pricing system architecture.

FIG. 19 is a schematic diagram as in FIG. 2 showing a representation of a complex business solution choreographed as a non-linear composition of services of CBM components.

FIG. 20 is a mock up of a screen shot of an interface for a tool for using CBM to support value based pricing of business solutions.

### DETAILED DESCRIPTION OF A PREFERRED EMBODIMENT OF THE INVENTION

A business solution delivers a specified set of capabilities that supports a business objective. It includes the people, technology, process, and other resources, that enable the business to achieve its purpose. A business solution can have wide ranging capabilities. The perceived complexity that enables a capability is based on point of view of the observer, thus establishing the notion of relative granularity. For example, a solution may appear from the consumer's point of view as a simple transaction, but from the provider's viewpoint may be an intricate and lengthy interaction between many business services. A business solution may in fact be a single business service or an aggregation of services. The idea of relative granularity is based on the level of decomposition of business capabilities that is suitable for management of the business.

A business value can be applied to every business solution. And since a business solution is a composition of one or more business services the value of the business solution can be viewed as the composition of values of the business services that support it. The present invention takes this approach, and provides a methodology for business value composition from services defined by the component business model (CBM) as described in the above referenced foundation patent application.

The decomposition of a business into discrete business components enables a business centric view of the enterprise and facilitates its management and transformation. CBM describes a basic organizing concept, a paradigm in which the business is seen as set of independent business components that collaborate to realize business solutions. A business component is a well bounded decomposition of an enterprise and houses an entire environment that constitutes that slice of the business. This includes all resources, infrastructure and facilities and that enable the business component it to achieve its business purpose.

One of the advantages of business decomposition is that the organizing framework provided by CBM can facilitate a more effective understanding of business problems, requirements and evaluation, and enables better solution generation than other frameworks provide. For example, rather than seeing a business as independent threads of processes that weave through the “blob” of the enterprise, in a business decomposition the focus is on business components that are endowed with specific business capabilities and resources, and how they interact with other components to enable the purposes of the business. This world view is particularly effective for business analysts and strategic business planners who need to see and evaluate the business holistically using an organizational perspective, considering many factors, including resources consumed (costs) and benefits generated (value). CBM supports a wide range of analytic techniques and methods within its framework and does not restrict the type or character of business evaluation.

In CBM, business components interact with one another to meet the business goals. To accomplish this, business components offer their capabilities through the business services they expose. The granularity of a business service in a CBM description of the components of the business is set to so that it is suitable to the purposes of the business and can support collaboration with other components. A business component can thus be viewed as a service center, a perspective that supports the strategically important notion of Service Oriented Architectures (SOA). The decomposition model is an idealized framework that expresses business strategies through components and, through extensions of the model, can be leveraged to realize these strategies. This realization includes the creation and modification of technology and processes, and the allocation of resources such as people and finance. In the case of IT technology, coupling of business strategy to IT realization can be achieved through the application of model driven transformation frameworks in which models of business requirement are successively mapped and transforming into models of IT implementation.

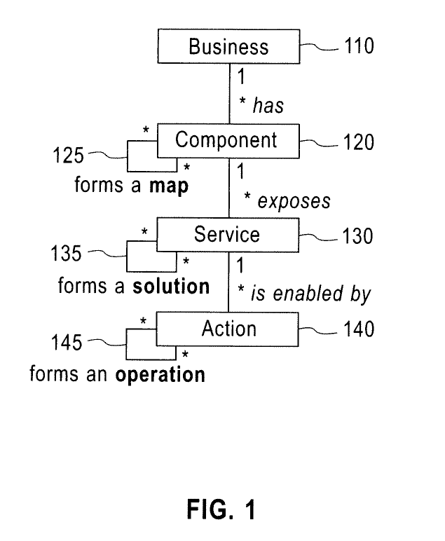

A simplified metamodel of the Component Business Model is illustrated in FIG. 1. A business 110 has a component 120 which exposes a service 130 which is enabled by an action 140. A component 120, along with other components, forms a map 125, and an exposed service 130, along with other services, forms a solution. An action 140, along with other actions, forms an operation 145.

FIG. 1 presents the following key elements and concepts:

Business 110: The logical representation of the complete and entire business.
Business Component 120: A partitioned unique chunk of the business responsible of all aspects of its business purpose.
Business Service 130: Business functions exposed by the component available to other components to consume
Business Action 140: Fined grained business functions encapsulated within the business component
CBM Map 125: The complete composition of the business from business components.
Solution 135: The complete composition of a business solution from business services.
Operation 145: The complete composition of a business service from business actions.

The Component Business Model reflects a level of granularity, as presented in Table 1, starting from the large grained level of the business element, with increasing fineness, through to business actions. This notion supports the concept of relative granularity, previously discussed, which facilitates an understanding between users with different points of view.

TABLE 1
Levels of Granularity

| Level | Element | Decomposition Level |
|---|---|---|
| 1 | Business | Complete Business |
| 2 | Component | Dedicated unit |
| 3 | Service | Available function |
| 4 | Action | Internal units of work |

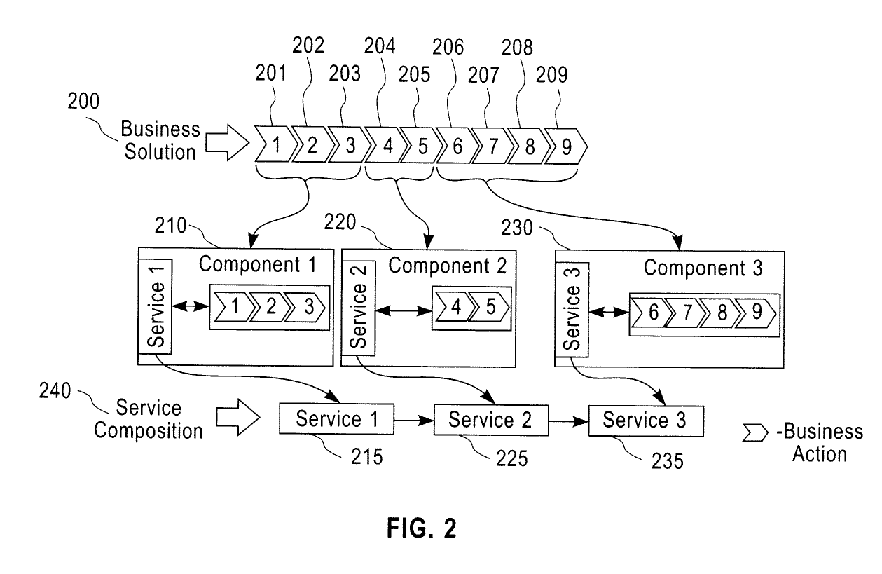

A business solution may be realized as a composition of business services that are choreographed to execute a sequence of finer grained business actions. In the Component Business Model business actions are encapsulated components and support business services. FIG. 2 illustrates the concept of a business solution 200 supported by a sequence of actions (201 through 209), and its logical equivalent as a graph of business services 240, which is composed of Service 1 (215), Service 2 (225), and Service 3 (235). As illustrated, Service 1 (215) is provided by Component 1 (210) through business actions 1, 2 and 3 (201 through 203), Service 2 (225) is provided by Component 2 (220) through business actions 4 and 5 (204 and 205), AND Service 3 (235) is provided by Component 3 (230) through business actions 6, 7, 8 and 9 (206 through 209).

It will be observed that because each component is a substantially self-contained locus for the resources required to perform its services, the component decomposition represented by a CBM map is suited to managing each component so as to optimize performance of its services, including outsourcing. Thus, composing a business solution of business services provides a flexibility that allows both the solution provider and consumer to employ the most effective service provider to meet business goals. Such concepts are represented in service architectures, dynamic or virtual enterprises and outsource solutions.

Providers and consumers can be thought of as general contractors, assembling and managing the whole enterprise from a set of parts, where each part is a business service associated with a business component. The Component Business Model represents a logical framework for the organization of a business, independent of how that logical framework is realized. In the extreme, the entire entity can be realized as a virtual business comprised of outsourced business services that are selected, choreographed and bound to form a business solution.

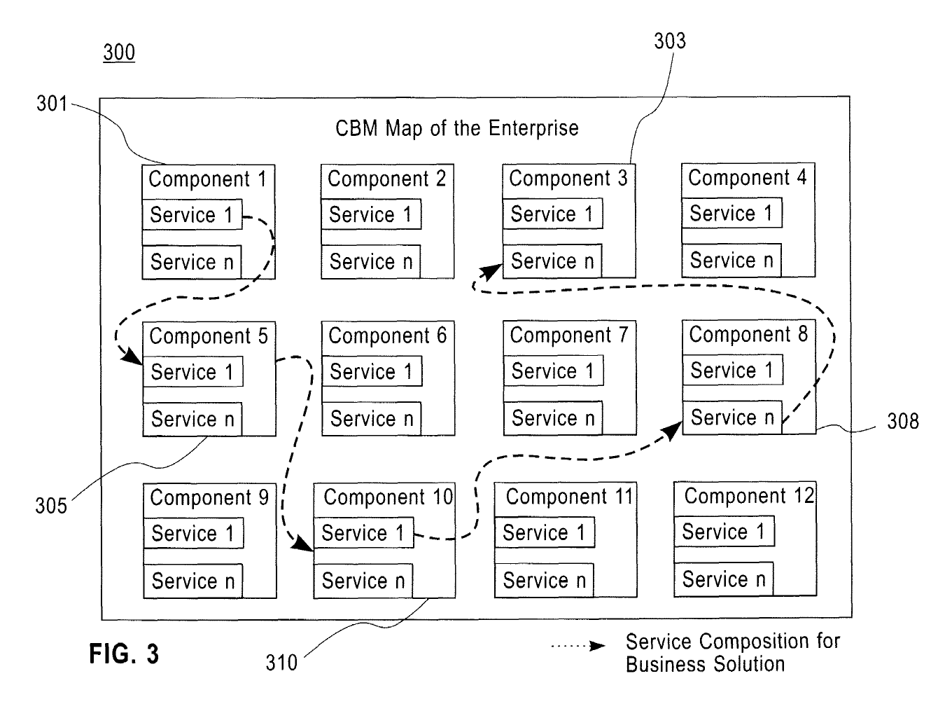

A business solution is thus represented as a directed graph of business service interactions within a logical business topology. This is illustrated in FIG. 3, in which the dotted line represents a simple choreograph of business services for a business solution. In the business solution illustrated, Service 1 provided by Component 1 (301) serves as an input to Service 1 of Component 5 (305), and this sequence continues through Service 1 of Component 10 (310), Service n of Component 8 (308), and Service n of Component 3 (303).

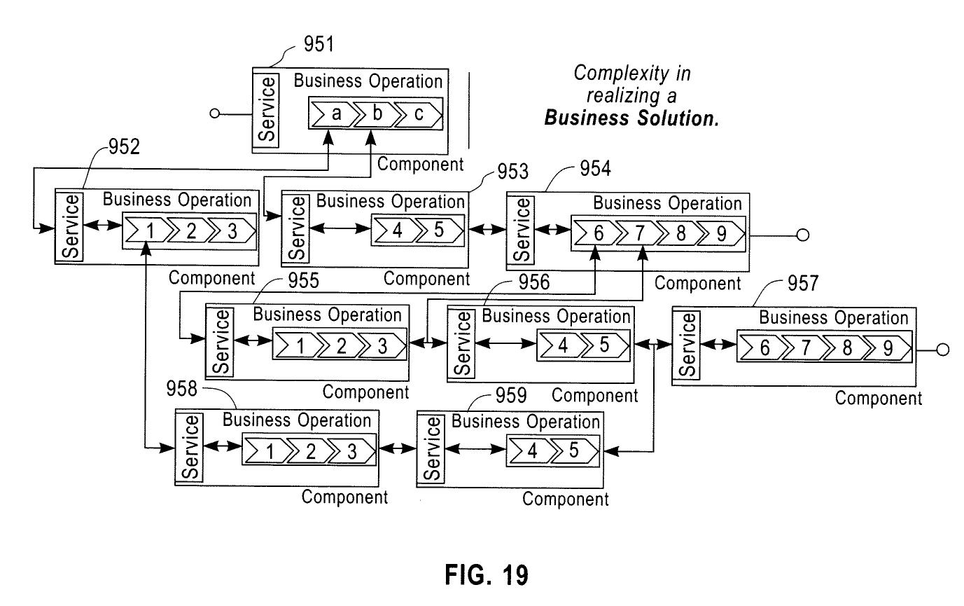

While the choreograph of services shown in FIGS. 2 and 3 are simple linear flows, in general service compositions may reflect complex business flows. For example, compare the flow shown in FIG. 2 with the more complex solution shown in FIG. 19. These more complex solutions can include the application of composition logic constructs such as forks, joins and loops, which enable the specification of control logic, concurrency and repetition. Service compositions can be represented by service specification languages such as Business Process Execution Language (BPEL). Throughout the remainder of this invention disclosure the concept of the virtual business will apply, meaning business services (i.e. the components that provide these services) may exist within an enterprise or may be outsourced to external entities.

Value based pricing includes a set of criteria focused on optimizing the cost and benefit of pricing between a provider and a consumer, for their mutual benefit. We observe that the notion of business value is an abstraction that is defined by the observer. There are infinite criteria for establishing what value means; what is of benefit to one entity may not have the same worth to another. For this discussion, value is a concept that specifies what is being examined, and provides a unit of measure and method for its calculation. The focus is on the pricing function exclusive of other factors that can influence price, such as those enumerated in the terms and conditions agreements that address schedule, quality or other specifications. In the context of transforming and supporting the purposes of the business, the business solution is the essential vehicle for change and accordingly, it is the asset to be priced using the value based pricing approach.

A pricing strategy is a method the business chooses to equate value to compensation. The range of pricing strategies is limited only by the ingenuity of the business analyst, and several business models have been proposed. Four common pricing considerations are:
1. Fixed Cost: a single set cost is determined which may be a flat fee, or compensation based on time and materials.
2. Usage: compensation is based on per use such as price per transaction or price per seat.
3. Shared Benefit: a partnership model based on sharing business return.
4. Performance: compensation incentives determined by meeting thresholds of measurable results.

These four strategies are not exclusive, but will be used to illustrate how the invention is implemented. A “value based pricing schedule” is a composition of one or more pricing strategies packaged together. Pricing a business solution using multiple strategies benefits both the consumer and the provider as it enables a focus on business objectives, mitigates initial expenditures, shares the risk and rewards business success.

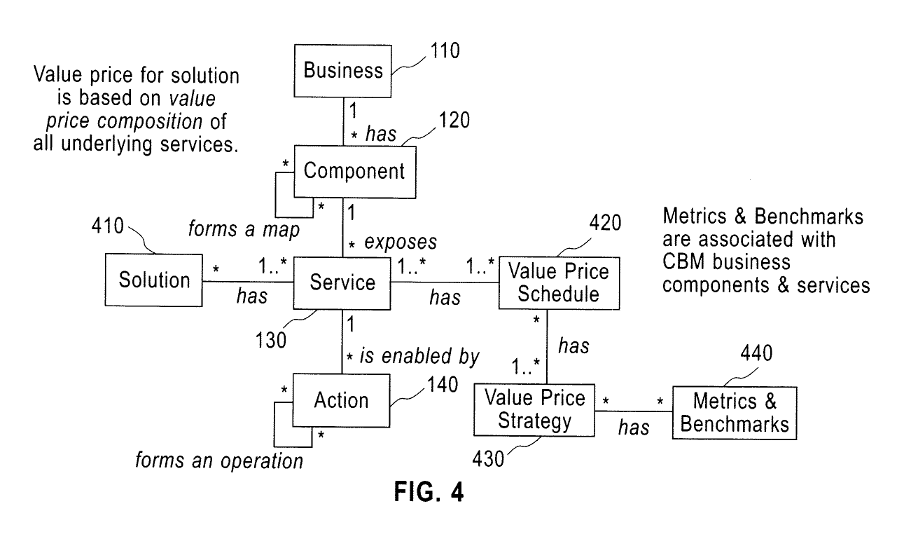

The Component Business Model directly supports the concepts of value based pricing for business solutions. Referring to FIG. 4, we extend the Component Business Model described in FIG. 1 to enable a business solution 410 to have associated with it the following additional elements:
Value Pricing Schedule 420: A value pricing schedule is a configuration of one or more pricing strategies which, when taken as a whole, represent a satisfactory cost or payment for a business solution. The model specifies the value based pricing schedule for a given service.
Value Pricing Strategy 430: A pricing strategy is a method the business chooses to equate value to compensation. The model specifies the value pricing strategies that can be applied to a value pricing schedule.
Metrics & Benchmarks 440: Metrics and benchmarks are associated with the business services. These metrics may be qualified by industry type, solution specification, historic data based on business records, or business rules established by subject matter experts.
The model specifies the metrics and benchmarks for a given value pricing strategy.

The revised simplified model allows business solution 410 to have multiple value based price schedules 420 based on an evaluation of the composition of business services 130 that constitute the business solution 410. It is up to the business 110 to rationalize a value based price for a business solution based on analytic techniques such as allocation and aggregation, as described below. Each business service 130 has one or more own value based pricing schedules 420, which are made up of one or more pricing strategies 430, for example, fixed cost or performance based compensation. The criteria and direction for selecting a value based price strategy and the assignment of its weight within the value based pricing schedule is suggested by the metrics and benchmarks 440 associated with the business service 130. These metrics 440 may be qualified by industry type, solution specification, historic data based on business records, or business rules established by subject matter experts.

Business composition and value based pricing are both complementary and synergistic, as described in the following enumeration of key intersections:

The Component Business Model describes the key concepts of business solution, business services and business activities, business criteria, and business decomposition that are all perceived as central to the notion of value based pricing.

The Component Business Model framework represents business solutions as an interaction of business components. Value based pricing is introduced as an evaluation technique that enables flexible pricing of business solutions.

A business solution is seen as composition of business services. The value based price of the business solution is determined by an evaluation the composition of the value based price associated with each business service.

A business service is enabled through an identified composition of people, process and technology. By applying value based pricing criteria and methods to a business service, a value based price for the service can be determined that considers these wide ranging factors which are implicit in the Component Business Model.

Implicit in the concept of business decomposition and business services is the notion of service outsourcing. Value based pricing is intricately woven with outsourcing efforts, which are transparent to value based pricing and therefore provide an incentive for the use and adoption of value based pricing.

The formalization of business decomposition establishes reusable benchmark standards that can be used to support value based pricing of business solutions for all industries.

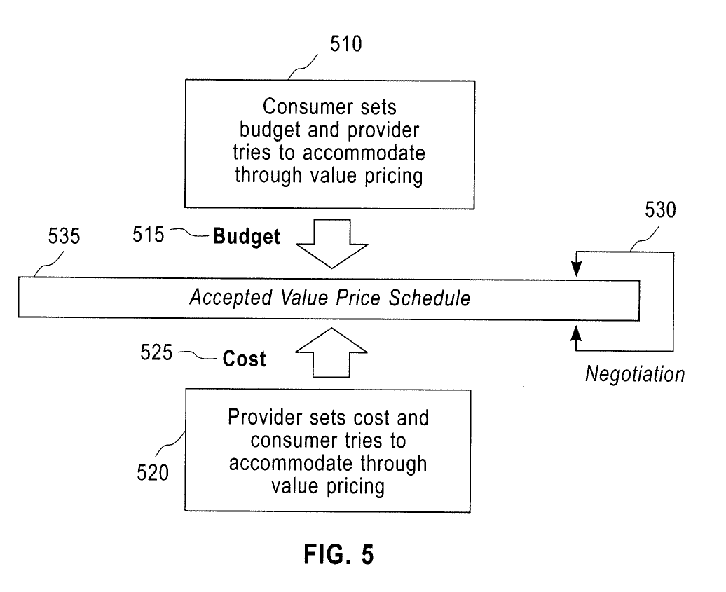

Arriving at an agreed to price is a negotiated process where the provider has a cost and the consumer has a budget. Each party possesses a set of criteria and objective functions that guide the negotiation. A successful negotiation results in a solution where the value to the provider and the consumer are both maximized to the greatest extent possible. An outline of the negotiation process is illustrated in FIG. 5. Note that either the budget or the cost can be represented as a value based pricing schedule. On the one hand, as summarized in item 510, the consumer sets the budget and the provider tries to accommodate the budget through value based pricing. Thus the budget 515 is the focus of negotiation 530 and the value based price schedule that is accepted 535 at the conclusion of the negotiation 530. On the other hand, as summarized in item 520, the provider sets cost and the consumer tries to accommodate through value based pricing. Thus cost 525 is the focus of negotiation 530 and the value based price schedule that is accepted 535 at the conclusion of the negotiation 530. This feature introduces an additional degree of complexity in negotiating an agreement between the provider and consumer.

TABLE 2
Styles of Negotiation

| Flow | Sets | Accommodates |
|---|---|---|
| Top-down | Consumer | Supplier |
| Bottom-up | Supplier | Consumer |

As described in Table 2, pricing negotiations can be “top-down”, meaning the consumer sets a price and the provider attempts to accommodate; or “bottom-up”, where the provider submits a price and the consumer attempts to meet it. This sets the stage for an iterative negotiation process that concludes when an accommodation by both parties is accepted.

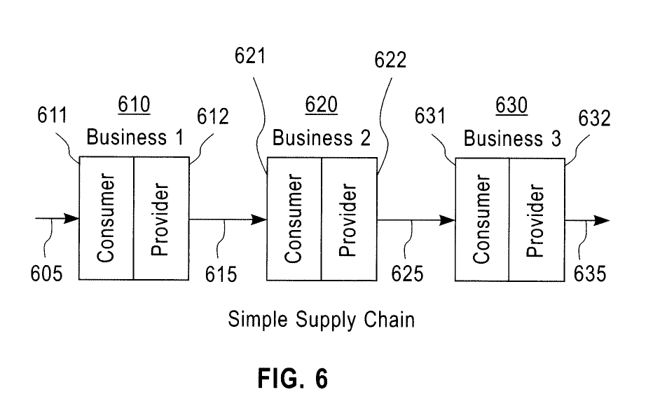

The service composition is a constituent part of a larger business ecosystem that describes a supply chain of business spanning the originating provider through to the ultimate end consumer. As illustrated in FIG. 6, in a supply chain a business may embrace dual personalities as both provider and consumer, dependent on the context and level they play in the chain. Business 1 (610) is a consumer 611 of incoming services 605 and a provider 612 of services 615. Similarly, business 2 (620) is a consumer 621 of services 615 and a provider 622 of services 625. Finally, business 3 (630) is a consumer 631 of services 625 and a provider of outgoing services 635. The chain as a whole begins with incoming services 605 and at the other end of the chain generates outgoing services 635.

The notion of an interdependent hierarchical network of providers and consumers has the consequence that modifications to pricing at one level may affect the pricing balance of the entire chain. As such, value based pricing through the entire supply chain is a challenge that might be solved iteratively until the entire structure is stable and in balance. That said, in this invention disclosure we examine the relationship between provider and consumer at a single level only, as reflected in FIG. 5. Those skilled in the art will appreciate that the teachings illustrated for a single level may be applied to a more complex supply chain.

When establishing cost, the solution provider has the challenge of considering the pricing relationship among all service providers that contribute to the solution. As described in Table 3 this can occur following one of two models, aggregation or allocation, depending on the flow of the negotiation.

TABLE 3
Value based Pricing for the
Service Provider

| Flow | Solution Provider | Service Provider |
|---|---|---|
| Top Down | Receives price from consumer | Receives allocation from |
| | and allocates portion to | solution provider. |
| | service provider. | |
| Bottom Up | Aggregates price received | Gives price to solution |
| | from service providers and gives | provider. |
| | to consumer. | |

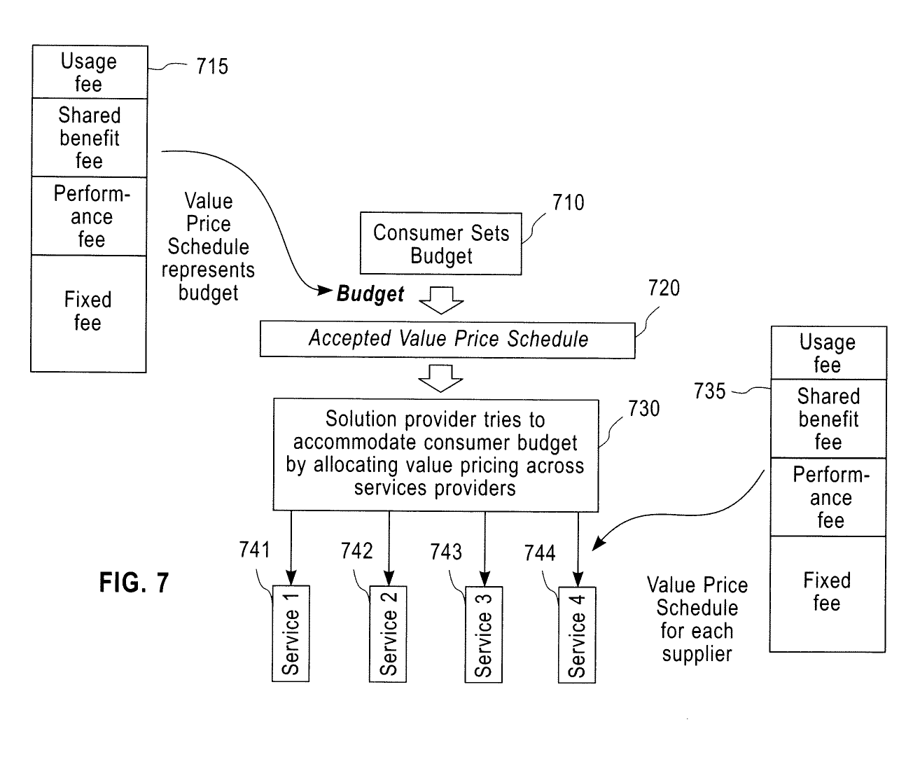

In a top down model, a budget is fixed by the consumer and the solution provider is asked to meet its pricing constraints contained in the value based price schedule contained in the consumers' budget. Since the solution is realized as a composition of services, the solution provider is required to negotiate with the constituent services, allocating a given portion of the budget to each. The value based price schedule need not be the same for each service provider—some providers may prefer a fixed payment upfront while others may choose a pricing model that uses costs. This is illustrated in FIG. 7, which examines a top down flow. A budget is set by the consumer 710, based on the value to the consumer's constituent services and represented by a value based price schedule 715. The solution provider 730 attempts to accommodate the consumer budget by using value based pricing analysis to allocate the budgeted compensation across the participating service providers (741-744), with a value based pricing schedule 735 for each. Should the solution provider not be able to meet the consumer's proposed budget, an alternate proposal is submitted for negotiation, until a value based pricing schedule is accepted 720.

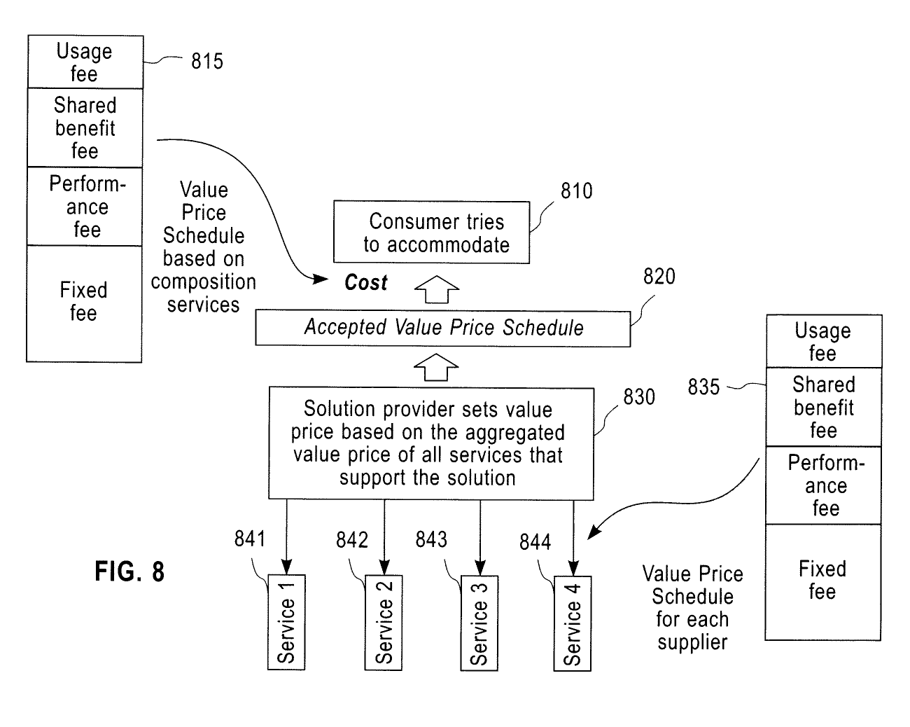

Given the added dimension of multiple pricing strategies within a pricing schedule, a larger domain of acceptable solutions will exist that may satisfy the constraints and aspirations of all business parties. It will be noted that, in principle, particularly where a participating service (e.g. 741, 742, 743 or 744) has been outsourced, each of these allocations may be negotiated and such negotiations will be interrelated by the common budget target 715 and, assuming negotiations are successful, as reflected in the accepted value based price schedule 720. It should also be observed that although the display of participating services in the figure suggests a parallel relationship, the relationship between participating services (e.g. 741, 742, 743 and 744) may be serial (as shown in FIG. 2) or more complex (as shown in FIG. 19). This observation applies as well to the participating services described below with respect to FIGS. 8, 9 and 10.

FIG. 8 illustrates a bottom-up value based pricing model in which the solution provider has an unconstrained pricing objective and presents a cost in the form of a value based price schedule 815 that the consumer 810 is asked to accommodate. Here the solution provider 830 is required to aggregate the pricing schedules 835 from the service providers 841-844 that compose the solution. Should the consumer be unable to meet the solution provider's proposed cost, an alternate proposal is submitted for negotiation, until a value based price schedule is accepted 820.

Calculating the budget of the consumer requires estimating the value of the work product produced by the consumer constrained by the costs of production of the consumer. This may be understood by recognizing that the consumer is also a provider, as shown in FIG. 6. For example, the budget of consumer 631 for the services 625 from provider 622 will be constrained by the compensation obtained by provider 632 for services 635. Since the consumer's business is logically supported by business services, the budget is seen as an evaluation of the composition of services that contribute to the creation of a work product. What results is a reflection of activities performed by the service consumer, only this time it results in the establishment of a consumer's budget (consumption oriented) as opposed to the providers cost (production oriented).

This is illustrated by Table 4, in which the control point for the consumer will either aggregate a budget from budgets of its constituent service providers or allocate a budget among its constituent service providers, depending on the flow of the negotiation.

TABLE 4
Value Based Pricing for the Consumer

| | | Constituent |
|---|---|---|
| Flow | Consumer | Service Provider |
| Top | Aggregates budget | Gives budget to |
| Down | received from service | consumer. |
| | providers and gives to | |
| | solution provider | |
| Bottom | Receives price from | Receives allocation |
| Up | solution provider & | from consumer. |
| | allocates portion to | |
| | service provider. | |

The consumer's viewpoint is a basic mirror image of the viewpoint of the solution provider considered in discussing FIGS. 7 and 8. However, for the consumer, constituent business services report the value of the solution consumed. This may again be understood by recognizing that the consumer is also a provider, as shown in FIG. 6. The value to consumer 631 of the solution 625 from provider 622 will be constrained by the compensation obtained by provider 632 for services 635. There are a variety of value based pricing strategies available to the business 630 for relating the compensation received for services 635 to the cost of solution 625 obtained from provider 622. The domain of these strategies is typically larger than in the linear chain shown in FIG. 6, because the value chain that results in compensation for the consumer is complex (see, e.g., FIG. 19), and the relative contributions of constituent consumer services who use a particular solution may be assessed in a variety of ways. The value chain or supply chain shown in FIG. 6 is a special case of what is known as a value network or business eco-system. The flexibility of value based pricing is ideally suited for these situations. An example of this is when a business upgrades an IT portfolio with new software, and each business component that uses it is assessed a charge in the form of a value based price schedule.

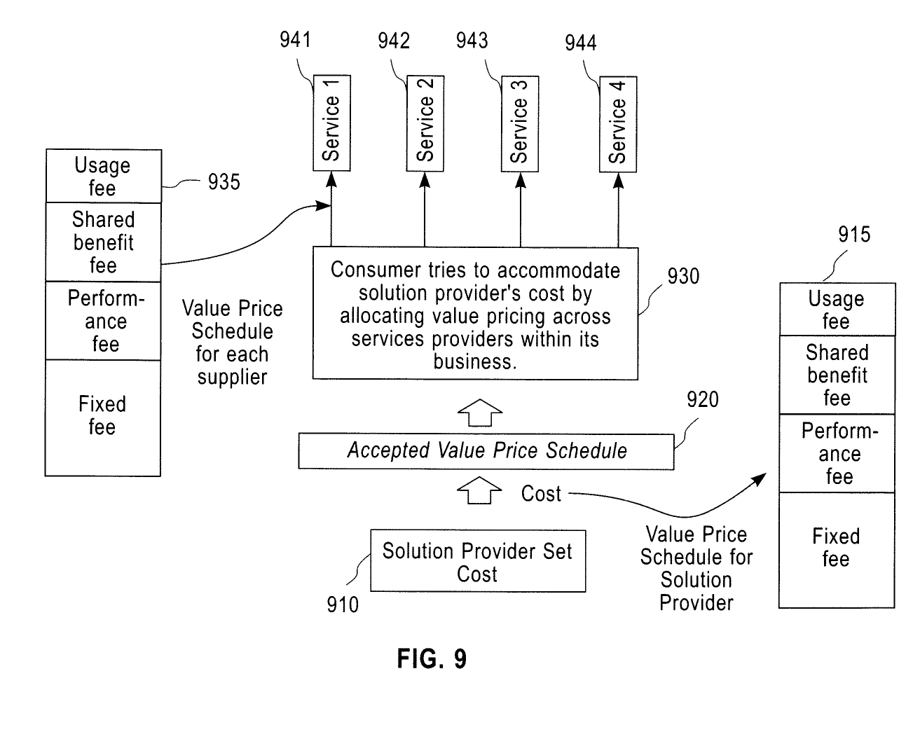

As illustrated in FIG. 9 a consumer 930 may attempt to accommodate a proposed cost 915 from a solution provider 910 by allocating the cost across all participating service consumers (e.g. 941, 942, 943 and 944), using a value based pricing schedule 935 for each. Should the consumer be unable to meet the solution provider's proposed cost by such an allocation, an alternate proposal is submitted for negotiation, until a value based price schedule is accepted 920.

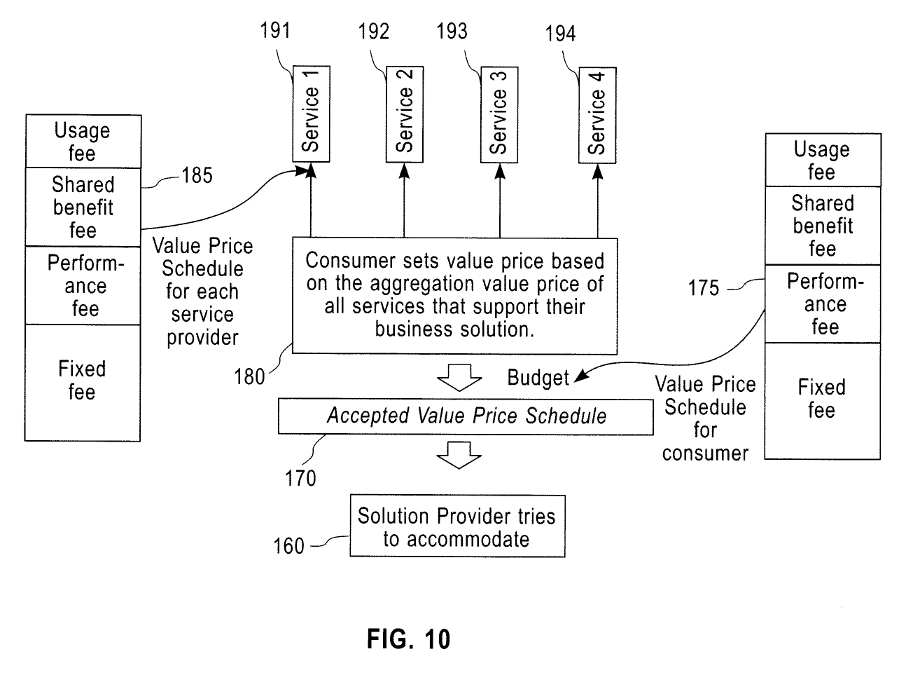

In the top-down approach shown in FIG. 10 a consumer 180 aggregates a value based price schedule 175 from value based pricing schedules 185 for each of the composition service consumers (e.g. 191, 192, 193 and 194) that support the construction of a work product by using the solution of the provider 160. Solution provider 160 tries to accommodate value based pricing schedule 175. Should the provider 160 be unable to meet the consumer's proposed budget, an alternate proposal is submitted for negotiation, until a value based price schedule in accepted 170. An example of this is when an IT portfolio is to be transformed with new software, and each business component that will use the new software reports what they are prepared to budget for this use (as qualified by business constraints such as schedule, resources and requirements) in the form of a value based price.

Symmetry between the solution provider and consumer facilitates a common analytic technique to compose a value based price schedule from constituent services. The value based pricing negotiation cycle results in an iterative process that contains two key loops:
1. An interaction between the solution provider and solution consumer in which a proposed budget or proposed cost in the form of a value based price schedule is presented by one party to the negotiation and is attempted to be accommodated by the other party.
2. An inner loop interaction between the solution provider and its constituent service providers, and between the solution consumer and its constituent service consumers. In this loop the proposed value based price scheduled is allocated or aggregated depending on the flow of the negotiations between the solution provider and the solution consumer.

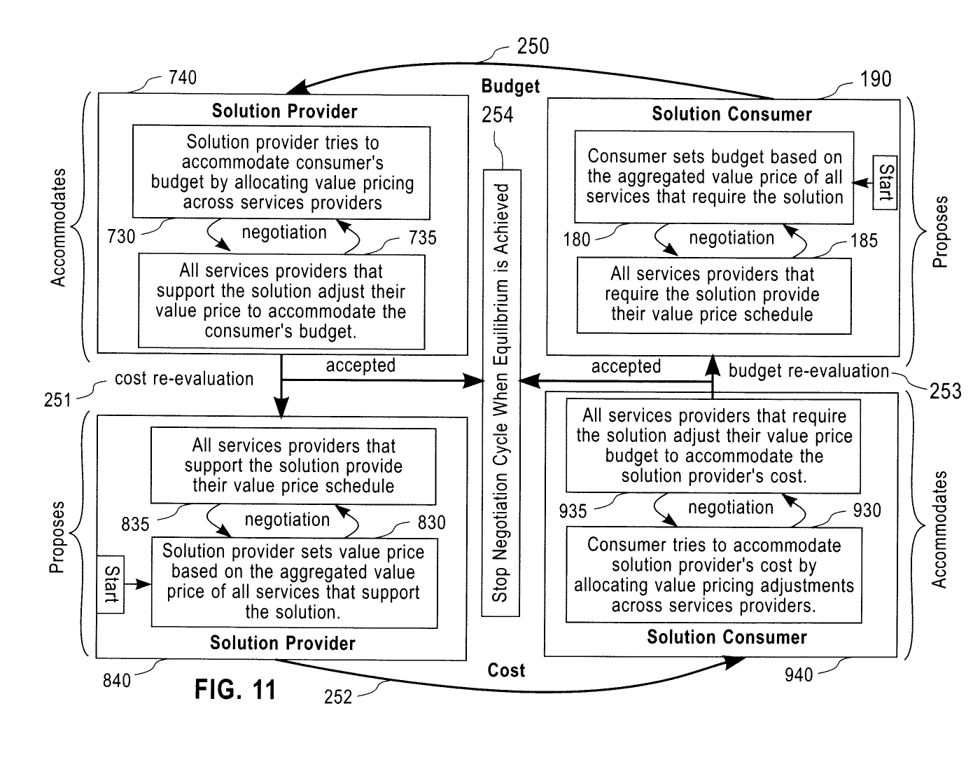

A summary of the value based price negotiation method showing these loops is presented in FIG. 11. In block 740, as in FIG. 7, the solution provider 730 receives a budget 250 from a solution consumer and tries to accommodate this budget by allocating value based pricing schedules 735 across its constituent service providers. In general, this allocation will be effected by a negotiation between the solution provider 730 and its constituent service providers, wherein all service providers that support the solution adjust their value based pricing schedule 735 to accommodate the consumer's budget. If the allocation is effective the budget proposal 250 is accepted 254 and the negotiation ends. Otherwise, the allocated cost is reevaluated 251 and the negotiation cycle continues.

In block 840, as in FIG. 8, the solution provider 830 sets a value based pricing schedule by aggregating value based pricing schedules 835 of all constituent service providers that support the solution. In general, this aggregation will be effected by a negotiation between the solution provider 830 and its constituent service providers. The aggregated schedule is then proposed to the solution consumer as a cost 252 to be accommodated. If the accommodation is effective the cost proposal 252 is accepted 254 and the negotiation ends. Otherwise the solution consumer's budget is reevaluated 251 and the negotiation cycle continues.

In block 940, as in FIG. 9, the solution consumer 930 tries to accommodate the cost 252 proposed by the solution provider by allocating value based pricing schedule adjustments 935 across the consumer's constituent service provides. In general, this allocation will be effected by a negotiation between the solution consumer 930 and its constituent service providers. If the allocation is effective the cost proposal 252 is accepted 254 and the negotiation ends. Otherwise, the allocated budget is reevaluated 253 and the negotiation cycle continues.

In block 190, as in FIG. 10, the solution consumer 180 sets a budget by aggregating value based pricing schedules 185 from all the constituent services that require the solution. In general, this aggregation will be effected by a negotiation between the solution consumer 180 and its constituent service providers. The aggregated budget is then proposed to the solution provider as a budget 250 to be accommodated. If the accommodation is effective the budget proposal 250 is accepted 254 and the negotiation ends. Otherwise the solution provider's costs are reevaluated 251 and the negotiation cycle continues.

The negotiations continue in this fashion until acceptance 254. It will be observed that FIGS. 7-10 focus on the two modes (i.e. accommodation by allocation, and setting by aggregation) of using composition of services in price negotiations, where the services are defined with reference to the component business model described in the above referenced foundation patent application. The four instances of these modes (two each for the provider and consumer) are shown in FIG. 11, and in particular by item numbers 730, 830, 930 and 180. However, it will also be observed, as noted above in connection with FIG. 7, that FIGS. 7-10 focus on only one side of a two-sided negotiation, and that the two mode accommodation/aggregation model can also be applied to the other side of the negotiation, provided that both sides are using the component business model to compose value based pricing schedules from constituent services. In FIG. 11, both the solution provider and the solution consumer are using the method described by the present invention. Those skilled in the art will appreciate that the method of the invention may be applied by one party to a negotiation, whether or not it is used by the other party.

There are many pricing approaches, but they may be grouped into three general categories. “Cost-plus” pricing calculates price based on cost plus a margin. This approach is often preferred by finance based organizations, since it tries to guarantee that each sale produces an adequate margin. “Market based” pricing sets price based on what competitors are doing. This approach is preferred by sales oriented organizations because it helps them sell against the competition. “Value based” pricing sets price based on an estimate of how a customer will perceive the value of the goods or services provided. This approach is often preferred by organizations focused on the customer.

In consulting services, value based pricing usually refers to the setting of a price as a function of the expected value to be derived from the services. The present invention expands and systematizes this view to include:
1. Pricing of business solutions built on a service composition model.
2. Establishing the notion of value price composition.
3. Enabling flexible value pricing through variable schedules of pricing strategies
4. Optimizing a pricing solution between provider and consumer for mutual benefit

In calculating a value based pricing schedule various objectives and business criteria need to be considered:
Objective functions such as a consumer budget.
Minimize functions such as risk and cost.
Maximize functions such as customer satisfaction, timeliness, and consumer and provider value.

Value based Pricing represents the ability to configure a pricing schedule from a set of pricing options such as: fixed cost, usage, shared benefit, and performance. A “one-price” policy has little merit in today's commerce. Flexibility and price dispersion facilitates business deals. Each pricing strategy has advantages and limitations with regard to sharing risks and rewards, and controlling expenditures. As reflected in Table 5, various pricing strategies can be applied to price a business solution.

TABLE 5
Pricing Strategies

| Services Contract | Description |
|---|---|
| Time and Materials | Consumer pays for hours and costs. |
| | Consumer takes risk. |
| Fixed Fee | Negotiated fee for scope work. Provider |
| | takes risk. |
| Performance Based | Fees for meeting preset goals. Shared risk |
| | and reward. |
| Shared Benefit | A partnership model based on business |
| | return. Shared risk and reward. |
| Utility Pricing | Pay as you go, suitable for service based |
| | solutions. Shared risk and reward. |

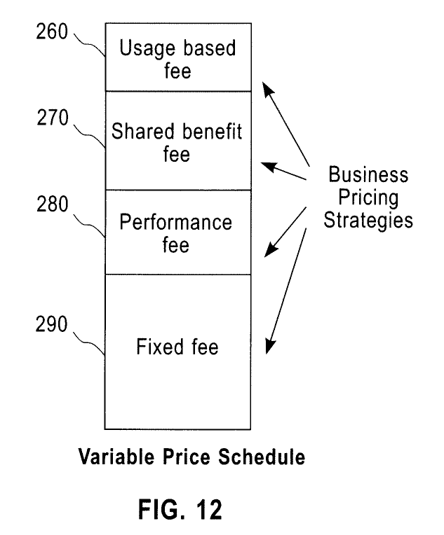

As shown in FIG. 12, a value based pricing schedule is a composition of one or more pricing strategies packaged together. For the purposes of illustration, the schedule shown in FIG. 12 includes four components: a usage based fee 260, such as time and materials, where the consumer bears the risk; a shared benefit fee 270; a performance fee 280; and a fixed fee 290, where the provider bears the risk. These components may be weighted in a variety of ways, and this flexibility is used in the negotiation process to reach an agreement that optimizes the value of the deal for both service provider and service consumer.

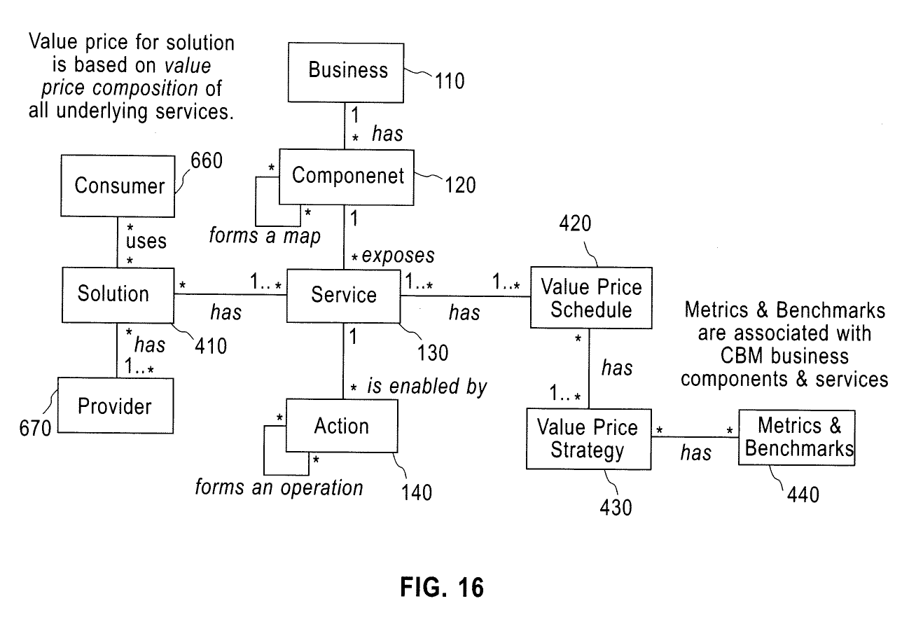

Pricing a business solution with multiple strategies benefits both the consumer and the provider as it can be applied flexibly to enable a focus on business objectives, mitigate initial expenditures, share the risk and reward business success. Value based pricing model relationships are illustrated by the metamodel shown in FIG. 16, described below.

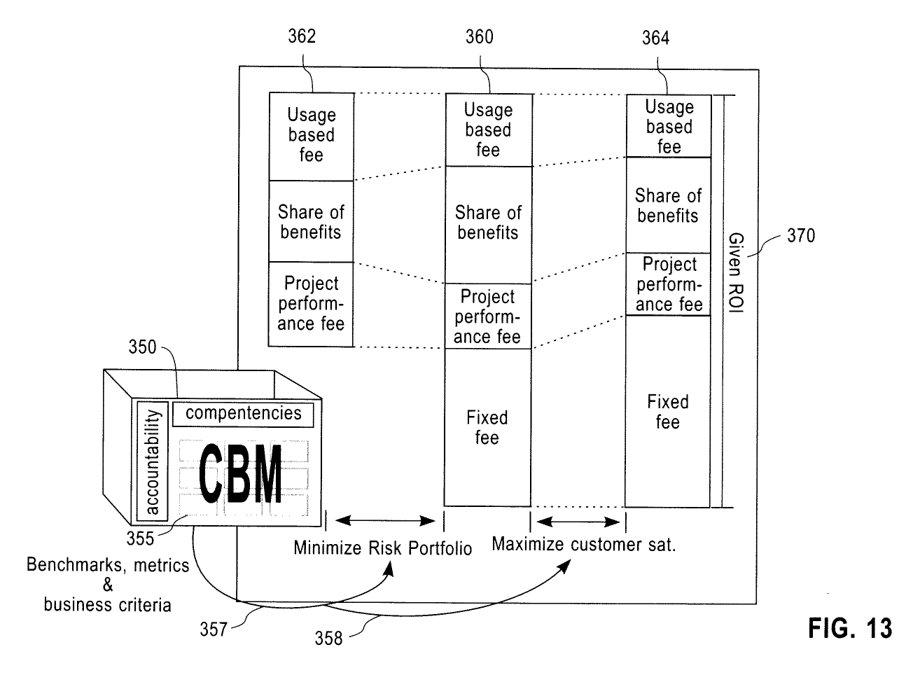

CBM enables business solutions to be identified as an interaction of business components, where each component provides a service, and where the solution is described as being composed of these business services. In addition, CBM links and aligns business criteria and objectives, business strategy, and business resources with benchmarks and other business metrics. This information is all required by value pricing techniques in order to calculate a composite value price as shown in FIG. 13. A simplified representation of a CBM map 350 shows a component 355. Services (not shown) of component 355 may be involved in consuming a solution (if CBM map 350 is a map of the solution consumer) or may be involved in developing a solution (if CBM map 350 is a map of the solution provider). In either case, as shown in FIGS. 7-10, the service of component 355 will have a value based pricing schedule 360 that reflects a composite of pricing strategies for recognizing the contribution made to the work of component 355 by the solution (if component 355 is part of the solution consumer), or reflects a composite of pricing strategies for estimating the value to the solution consumer contributed by the services (if component 355 is part of the solution provider). For a given return on investment (ROI) 370, for example, these benchmarks, metrics and business criteria may be applied to adjust pricing schedule 360 so as to minimize risk portfolio 357 or maximize customer satisfaction 358, or come to some intermediate pricing strategy.

In broad conceptual terms, these variations are indicated in FIG. 13 by the lack of a fixed fee component in the pricing strategy 362 designed to minimize a service providers risk, and by the increased fixed fee in the pricing strategy 364 designed to maximize consumer satisfaction. Because of the analytical foundation provided by CBM, these variations in the pricing schedule for a particular service can be linked to the benchmarks, metrics and business criteria associated with the CBM model. It will be understood, therefore, that different business criteria will result in different pricing schedules.

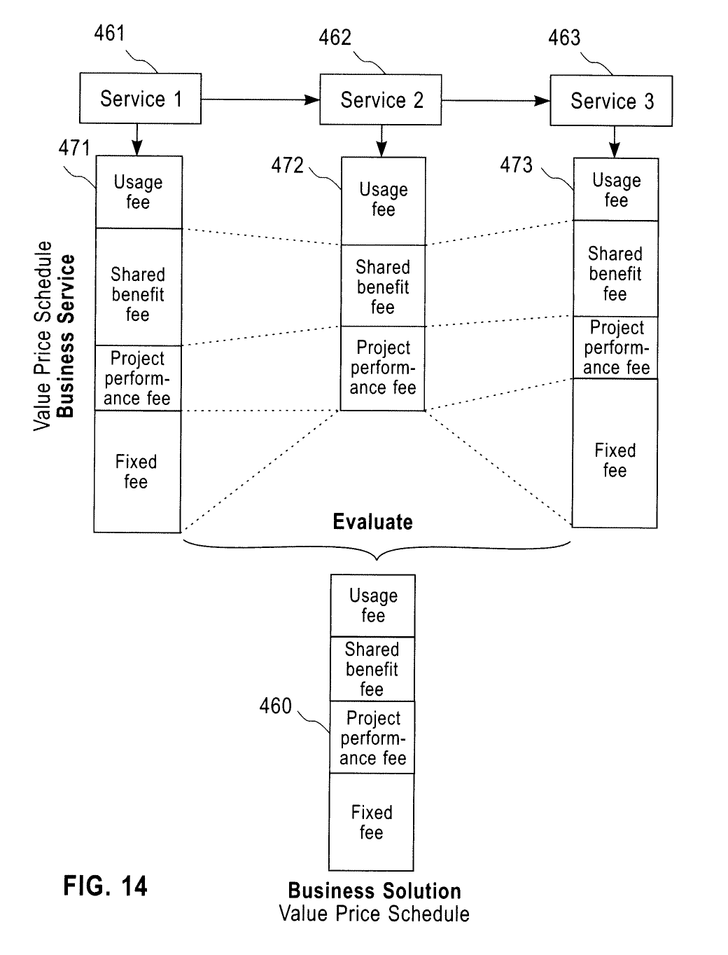

In “value based price composition” the value based price of a business composition is a composite produced by the evaluation of all business services that support the business solution, as shown in FIG. 14. In other words, the price for a given business solution is an analysis of the value based pricing for each business service in the assemblage of services that make up the solution. For example, if a business solution is composed of service 1 461, service 2 462 and service 3 463, then a value price schedule 460 for the business solution would be composed from an evaluation of value price schedule 471 for service 1, value price schedule 472 for service 2, and value price schedule 473 for service 3. The composed value price schedule 460 is not necessarily a simple arithmetic calculation, but is rather the product of an evaluation and analysis that takes account of non-linear synergies and other aspects of the relationships between and among the constituent services.

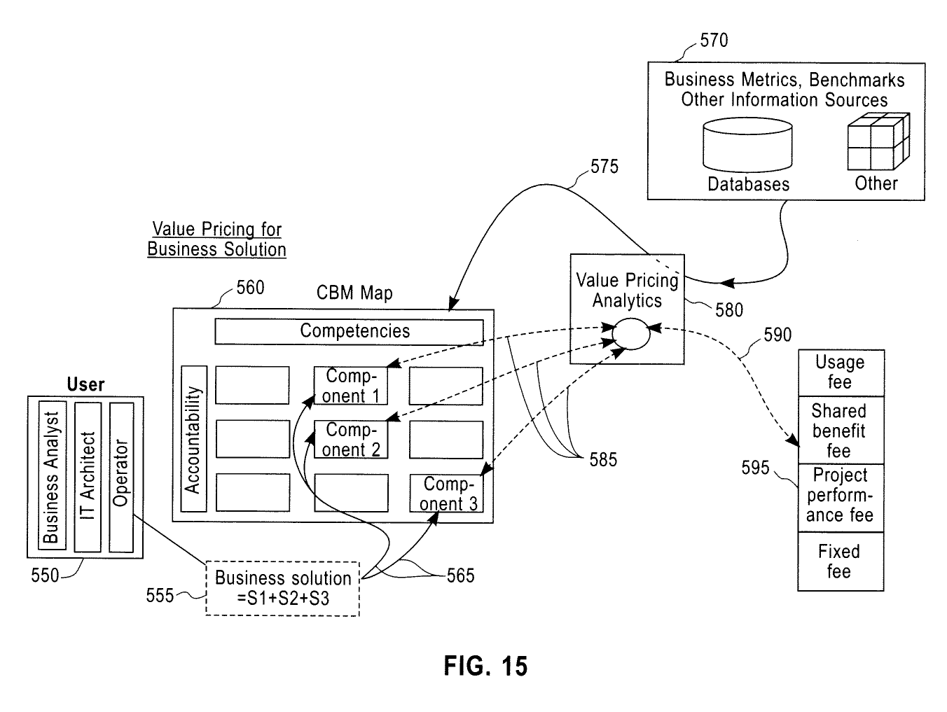

The present invention is based on the notion that CBM can be extended to be used as a framework in which to organize and present information for analysis of price for a business solution composed from services, and then to generate value based pricing schedules synthesized from the results of that analysis. A preferred embodiment of the invention is presented in FIG. 15. A user 550 of the invention may be a business analyst or IT architect, for example, or a wide range of other roles in the business. The invention presents the business solution 555 to the user 550 through the lens of a CBM map 560. For example, a business solution 555 composed of constituent services S1, S2, S3 . . . will be highlighted on the CBM map 560 in terms of the components 565 which provide the corresponding services.

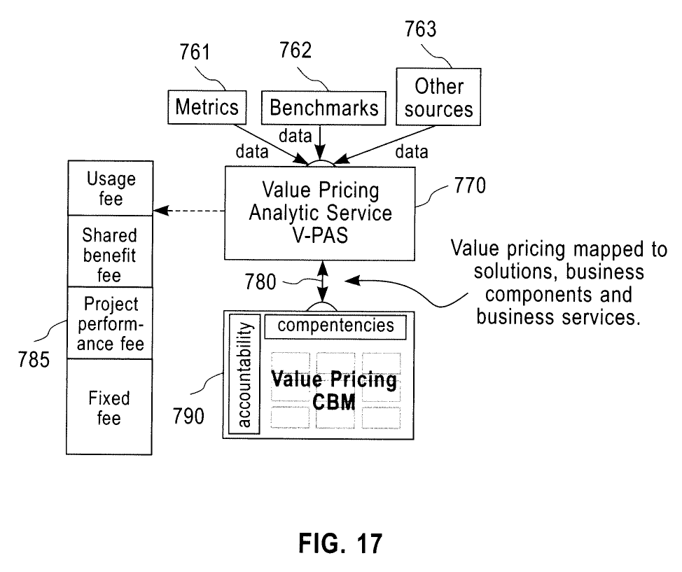

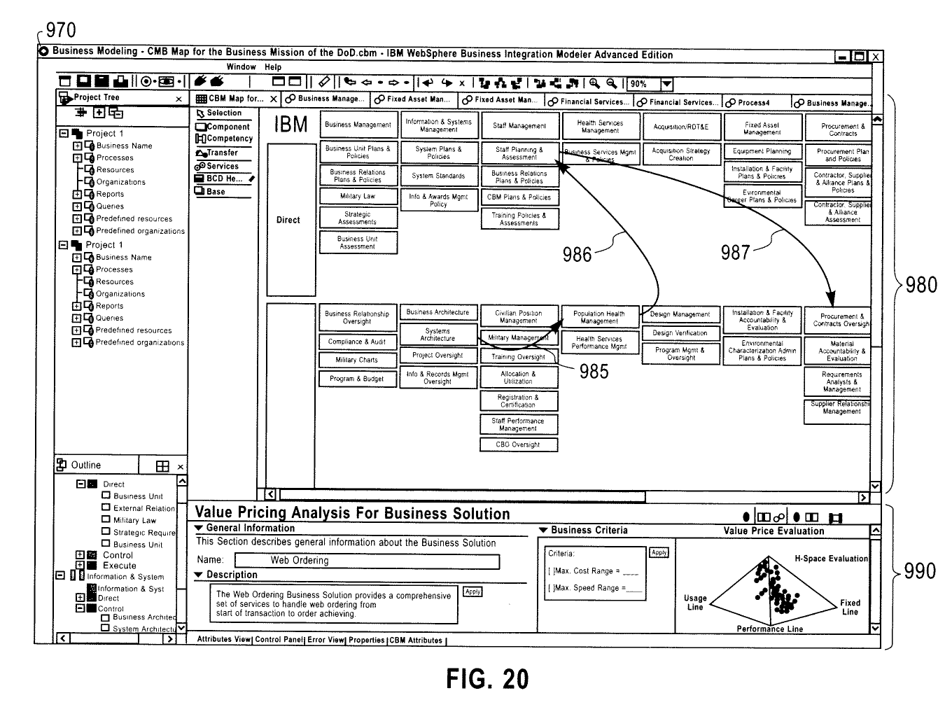

As described in further detail in the above referenced foundation patent application, the CBM map 560 serves as a repository for business information organized by component or other structure in the CBM metamodel. This information can be reached from a display of CBM map 560 by drill-down techniques well known in the art, including use of graphic overlays and companion windows, as demonstrated below in connection with FIG. 20. In order to adapt the CBM model to value based pricing, it is first necessary to incorporate into the CBM map 560 the information 570 of particular relevance to value based pricing. This information 570 will include business metrics, benchmarks, and other related business information useful in evaluating pricing solutions. This information 570 is then mapped 575 to CBM components and other CBM structures defined in the CBM metamodel (e.g. competencies and accountability levels), using the CBM map 560 as the organizing reference. In a preferred embodiment of the invention, this mapping is done by a value pricing analytic service (V-PAS) 580, as further described below in connection with FIG. 17. V-PAS accesses the data 570 and follows rules and procedures established for the mapping.

The information 570, which has now been added to the CBM map 560, together with evaluation parameters provided by the user 560, provide the basis for the next step. The next step is to formulate a value based pricing schedule for each of the constituent services (e.g. S1, S2, S3) of business solution 555. There are four possibilities, as shown previously in FIGS. 7-10, depending upon a) whether CBM map 560 describes the solution provider or the solution consumer, and b) whether the value based pricing schedule of the constituent services are to be aggregated or allocated. If the schedules 585 for the constituent services are to be aggregated, they are combined 590 in an evaluation that results in a value based pricing schedule 595 for the business solution. Alternatively, if schedule 595 has been set, then schedules 585 are determined in response to an allocation of the set schedule, as indicated in FIG. 15 by the direction of arrows flowing from schedule 595 toward CBM map 560. In a preferred embodiment, recommendations of value based pricing schedules for services (whether for aggregation or in response to an allocation) are prepared by value pricing analytic service 580, as shown in FIG. 15.

The simplified metamodel of FIG. 4 is further expanded in FIG. 16 to present the following additional elements:
Consumer 660: The entity that uses a business solution 410.
Provider 670: The entity that constructs (composes) the solution from business services.

A solution 410 has a provider 670.

These additional elements complete the metamodel for use in understanding the negotiation of value based pricing schedules as described in FIG. 11.

FIG. 17 presents a system level architecture that supports a preferred embodiment of the invention. The system architecture consists of three key elements:
1. Applications, services and databases provide business metrics 761, benchmarks 762 and other related business information 763.
2. A unique Value-Pricing Analytic Service (V-PaS) 770, introduced in the exemplar of this invention shown in FIG. 15, accesses data and reports, and follows rules and procedures for mapping 780 the data (761, 762 and 763) to CBM components and other CBM structures that are defined within the CBM metamodel. The user provides solution evaluation parameters through an interface that uses components and CBM 790 as a lens for viewing business solutions and the information related to the pricing of these business solutions. Using these evaluation parameters, coupled with the related business information that has been mapped 780 to the CBM structure, V-PAS 770 runs analytic functions and generates value based pricing recommendations 785 for use in the above described negotiations. V-PAS provides a framework within which a variety of value based pricing techniques, algorithms and methods may be installed and made available for selection and use in a variable price schedule 785 (as described above in connection with FIG. 12).
3. The Value Based Pricing CBM (VP/CBM) function 790 is enabled by representation upon the CBM map of the enterprise business information encoded by color, pattern or contained in object attributes. By selecting visual elements of the CBM map, the user can “drill-down” to obtain detailed information about value pricing and business information for any CBM element associated with a solution or the services that make up the solution. The VP/CBM 790 provides an interface by which the user can initiate value pricing activities, and specify parameters, business constraints and other business information required by the value based pricing techniques selected for inclusion in the variable price schedule 785.

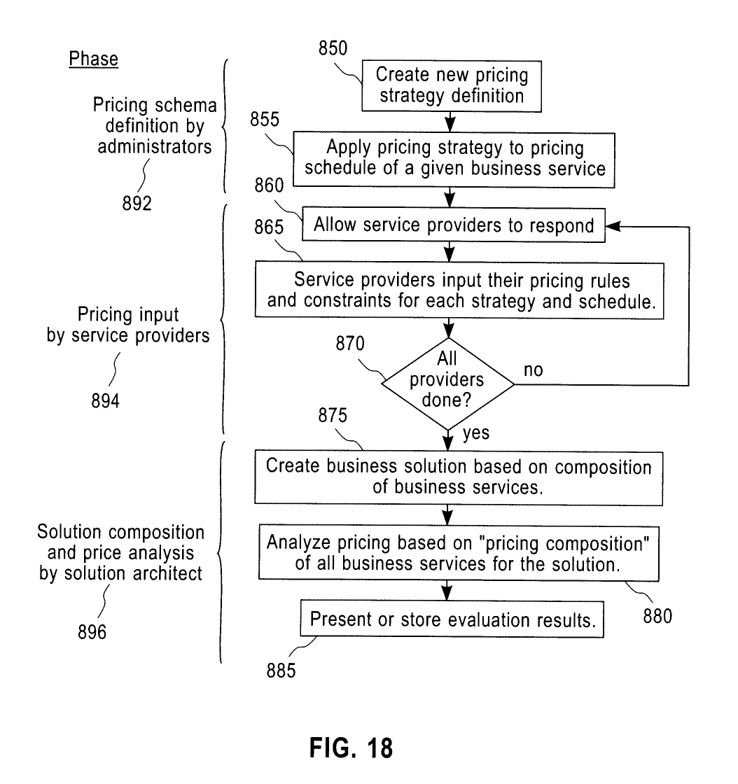

FIG. 18 presents the phases and method for establishing value based pricing in CBM. These include a schema definition phase 892 in which administrators define new pricing strategies 850 and apply them to a pricing schedule for a given business service 855. In a second phase 894, pricing input is provided by service providers. This input specifies the rules, constraints and values in accordance with the schema definitions 892. This phase allows each constituent service provider to respond 860, by inputting their pricing rules and constraints for each pricing strategy and pricing schedule 865, until all providers are accounted for 870. In the last phase 896, a pricing schedule for the business solution is composed from pricing schedules for constituent services that comprise the business solution 875. A pricing analysis is performed 880 by various parties including the solution architect, the consumer and the provider. This analysis is exploited and refined by the negotiation described above in connection with FIG. 11, resulting in an accepted pricing schedule which is then stored 885 in the CBM database for later re-use. It should be noted that the accepted pricing schedule which is result of the collaborative negotiation between solution provider and solution consumer can be stored 885 in the CBM databases of both the provider and the consumer, as well as in any broader industry and universal databases that may be available to the provider and the consumer.

FIG. 19 is a more complex illustration of the composition of a business solution from services. A simple linear composition of services was described above in connection with FIGS. 2 and 3. In general, a composition of services for a business solution will not be linear, and will include a variety of interactions, some of which are illustrated in FIG. 19. The business solution described in FIG. 19 is composed from services provided by components 951 through 959, triggered by an input to the service provided by component 951. However, the solution is not composed from service to service along a chain. For example, inputs to components 952 and 953 are provided from component 951, but not from the service output provided by component 951, which is not used. Instead, these inputs are provided by business actions “a” and “b”, respectively, from the business operation performed by component 951. This may be viewed as a fork from component 951 to components 952 and 953. Similarly, business actions “6” and “7” in the business operation performed by component 954 provide service inputs to components 955 and 956, respectively. Business action 1 in the business operation performed by component 952 provides an input to the service provided by component 958. Service outputs from components 953 and 958 provide inputs for the services provided by components 954 and 959, respectively. The service outputs from both components 956 and 959 are joined as input to the service provided by component 957. Similarly, there is a join at the service input to component 956, formed by the service output of component 955 and business action “7” from the business operation performed by component 954. In the end, the solution is comprised of the service outputs of components 954 and 957.

FIG. 20 presents an illustration of a CBM Value Pricing Tool Interface 970 for implementing the invention. The illustration highlights three key features:
1. The CBM map 980 of the enterprise consists of an ordered presentation of business components.
2. A business solution is composed from services provided by the components connected by lines 985, 986 and 987. The solution is shown as an interactive graph of business components that provide the function though the business services they expose.
3. A value pricing “analysis center” 990 that displays such information as (a) information on the business solution, such as the title “Web Ordering” and a description (e.g. “the Web Ordering business solution provides a comprehensive set of services to handle web ordering from start of transaction to order archiving”); (b) a user selectable set of “business criteria” for specifying constraints upon the value pricing analysis; and (c) results of value pricing analysis presented in a graphic form.

Those skilled in the art will appreciate that the area occupied on interface 970 by “analysis center” 990 may also be used to set up the analysis using tools that interact with CBM map 980 to display and highlight the information mapped to the CBM database (e.g. by the V-PAS described in FIGS. 15 and 17) and other information available in the CBM database.

Those skilled in the art will further appreciate that the concept of multiple pricing strategies within a pricing schedule, as described above in connection with FIGS. 12 and 13, introduces various topics that are ripe for advanced research. From a business viewpoint, these include: implications and affects of value based pricing within the entire supply chain ecosystem; supporting value based pricing in a virtual business environment; and dynamic value based pricing for dynamic service compositions.

With regard to analytical and evaluative techniques, challenges include: flexible ways to handle multivariate and businesses criteria; how to create an effective aggregation and allocation pricing mechanisms; approaches for forming a unified technique for both providers and consumers; and scalable mathematics for supporting the iterative negotiation process.

In this invention disclosure we have presented a framework and suggested some analytic techniques to support flexible pricing for business solutions. This examination has focused on a concept of value based pricing, which is represented as a pricing schedule consisting of a set of pricing strategies whose configuration satisfies the solution provider and consumer. In value based pricing, arriving at an acceptable price involves an iterative negotiation process between the solution provider and consumer, and well as their respective business service partners. Value based pricing introduces new complexities to an already challenging business and technical environment. However, value based pricing facilitates new business collaborations and opportunities, which is a compelling incentive for continuing research in this area.

While the invention has been described in terms of a single preferred embodiment, those skilled in the art will recognize that the invention can be practiced with modification within the spirit and scope of the appended claims.

Having thus described our invention, what we claim as new and desire to secure by Letters Patent is as follows:

1. A method for pricing a business solution, comprising:
describing the business solution as a composition of services, each service being exposed by a corresponding business component in a component business model (CBM) of an enterprise;
developing a value based pricing schedule for the business solution, the pricing schedule being configured from a plurality of pricing strategies to optimize a mutual benefit to a solution provider and a solution consumer;
applying the value based pricing schedule to each of the services constituting said composition; and
composing a value based pricing schedule for the business solution from the constituent pricing schedules.

2. A method as in claim 1, further comprising mapping of pricing information to the component business model.

3. A method as in claim 2, further comprising displaying said mapped pricing information on a map of the component business model.

4. A method as in claim 1, wherein said applying is by the solution provider to the constituent services contributing to the business solution.

5. A method as in claim 1, wherein said applying is by the solution consumer to the constituent services consuming the business solution.

6. A method as in claim 1, wherein said applying is by the solution provider to the constituent services contributing to the business solution and by the solution provider to the constituent services contributing to the business solution.

7. A method as in claim 6, further comprising iteratively negotiating the value based pricing schedule between the solution provider and the solution consumer.

8. A method as in claim 7, wherein the negotiating further comprises one or more of:
setting of a budget by the solution consumer, and accommodating by the solution provider to the set budget by allocating value pricing across the constituent services contributing to the business solution;
setting of a value based pricing schedule by the solution provider by aggregating value based pricing schedules from the constituent services contributing to the business solution, and accommodating by the solution consumer to the value based pricing schedule set by the solution provider;
setting of a cost by the solution provider, and accommodating by the solution consumer to the set cost by allocating value pricing across the constituent services consuming the business solution; and
setting of a value based pricing schedule by the solution consumer by aggregating value based pricing schedules from the constituent services consuming the business solution, and accommodating by the solution provider to the value based pricing schedule set by the solution consumer.

9. A method as in claim 2, wherein the mapping is performed by a value pricing analytic service.

10. A method as in claim 9, wherein the developing of a value based pricing schedule is performed by the value pricing analytic service.

11. A system for pricing a business solution, comprising:
means for describing the business solution as a composition of services, each service being exposed by a corresponding business component in a component business model (CBM) of an enterprise;
means for developing a value based pricing schedule for the business solution, the pricing schedule being configured from a plurality of pricing strategies to optimize a mutual benefit to a solution provider and a solution consumer;
means for applying the value based pricing schedule to each of the services constituting said composition; and
means for composing a value based pricing schedule for the business solution from the constituent pricing schedules.

12. A system as in claim 11, further comprising means for mapping of pricing information to the component business model.

13. A system as in claim 12, further comprising means for displaying said mapped pricing information on a map of the component business model.

14. A system as in claim 11, wherein said applying means is applied by the solution provider to the constituent services contributing to the business solution.

15. A system as in claim 11, wherein said applying means is applied by the solution consumer to the constituent services consuming the business solution.

16. A system as in claim 11, wherein said applying means is applied by the solution provider to the constituent services contributing to the business solution and by the solution provider to the constituent services contributing to the business solution.

17. A system as in claim 16, further comprising means for iteratively negotiating the value based pricing schedule between the solution provider and the solution consumer.

18. A system as in claim 17, wherein the negotiating means further comprises one or more of:
means for setting of a budget by the solution consumer, and accommodating by the solution provider to the set budget by allocating value pricing across the constituent services contributing to the business solution;
means for setting of a value based pricing schedule by the solution provider by aggregating value based pricing schedules from the constituent services contributing to the business solution, and accommodating by the solution consumer to the value based pricing schedule set by the solution provider;
means for setting of a cost by the solution provider, and accommodating by the solution consumer to the set cost by allocating value pricing across the constituent services consuming the business solution; and
means for setting of a value based pricing schedule by the solution consumer by aggregating value based pricing schedules from the constituent services consuming the business solution, and accommodating by the solution provider to the value based pricing schedule set by the solution consumer.

19. Implementing a service for pricing a business solution, comprising the method of:
describing the business solution as a composition of services, each service being exposed by a corresponding business component in a component business model (CBM) of an enterprise;
developing a value based pricing schedule for the business solution, the pricing schedule being configured from a plurality of pricing strategies to optimize a mutual benefit to a solution provider and a solution consumer;
applying the value based pricing schedule to each of the services constituting said composition; and
composing a value based pricing schedule for the business solution from the constituent pricing schedules.

20. The method of implementing a service as in claim 19, further comprising iteratively negotiating the value based pricing schedule between the solution provider and the solution consumer, wherein the negotiating further comprises one or more of:
setting of a budget by the solution consumer, and accommodating by the solution provider to the set budget by allocating value pricing across the constituent services contributing to the business solution;
setting of a value based pricing schedule by the solution provider by aggregating value based pricing schedules from the constituent services contributing to the business solution, and accommodating by the solution consumer to the value based pricing schedule set by the solution provider;
setting of a cost by the solution provider, and accommodating by the solution consumer to the set cost by allocating value pricing across the constituent services consuming the business solution; and
setting of a value based pricing schedule by the solution consumer by aggregating value based pricing schedules from the constituent services consuming the business solution, and accommodating by the solution provider to the value based pricing schedule set by the solution consumer.
